(19) United States
(12) Patent Application Publication
(10) Pub. No.: US 2012/0144007 A1
(43) Pub. Date: Jun. 7, 2012

(54) METHOD FOR SESSION TRANSFER MECHANISM BETWEEN COMMUNICATION DEVICES

(75) Inventor: Khong Neng Choong, Kuala Lumpur (MY)

(73) Assignee: MIMOS BERHAD, Kuala Lumpur (MY)

(21) Appl. No.: 13/128,169

(22) PCT Filed: Oct. 30, 2009
(86) PCT No.: PCT/MY09/00178

§ 371 Date: Oct. 25, 2011

(30) Foreign Application Priority Data
Nov. 7, 2008 (MY) PI 20084462

(51) Int. Cl. G06F 15/16

(52) U.S. Cl. 709/223

(57) ABSTRACT

A method (100) for session transfer mechanism between communication devices. The method (100) comprises the steps of triggering a session transfer (102) on an first device having an active session with a corresponding device, identifying a second device (104) from a plurality of devices for the session transfer, transferring the active session (106) transpiring between the first device and the corresponding device to between the second device and the corresponding device, and reclaiming the active session (108) transpiring between the second device and the corresponding device if a session reclaiming is triggered on the first device.

### FIELD OF INVENTION

The present invention relates to a method for session transfer mechanism between communication devices.

### BACKGROUND ART

Device switching is a mechanism where an application or session is switched or transferred from one communication device to another. These sessions are normally active ongoing sessions such as voice calls, video calls, conference calls, software simulations and many other applications having similar effect. The implementation of device switching or session transfer has become increasingly accepted by users especially with the variety of device types and functions therein as well as the advancement in the telecommunication industry.

Session transfer provides users with flexibility of executing applications, storing, processing and transferring data as well as eliminating dependency on a single device or a fixed location. With the increase in demand for seamless mobility, there is a constant need for improvement and betterment in the execution of session transfer to allow users to seamlessly implement device switching.

The common and conventional implementation of device switching requires a user to have addressing information of the target device for the switching purpose. The addressing information is fundamentally an IP address of the target device, assuming the device is an IP compatible device. The user is then required to input the IP address upon initiation of a session transfer so as to execute the device switching. Such restriction of having to be aware of the addressing information of the target device degrades the users' experience as far as seamless mobility is concerned, as the same interrupts the ongoing active session.

More complication arises when a user is unaware that he has input the wrong addressing information or IP address upon initiation of a session transfer. This result in the generation of errors and to some extent could disrupt the ongoing active session.

Additionally, another constraint of the conventional implementation of session transfer is the limitation of the point of control of the active session. The point of control remains with the active device, the device where the active session was switched from. This limits the flexibility and usability of seamless session transfer where the passive device, the device where the active session was switched to, with regards to point of control of the ongoing active session.

### SUMMARY OF INVENTION

In one embodiment of the present invention is a method for session transfer mechanism between communication devices. The method comprises the steps of triggering a session transfer on a first device having an active session with a corresponding device, identifying a second device from a plurality of devices for the session transfer, transferring the active session transpiring between the first device and the corresponding device to between the second device and the corresponding device and reclaiming the active session transpiring between the second device and the corresponding device if a session reclaiming is triggered on the first device.

The present invention consists of several novel features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE ACCOMPANYING DRAWINGS

For the purpose of facilitating an understanding of the present invention, there is illustration in the accompanying drawings, from an inspection of which, when considered in connection with the following description, the invention, its construction and operation and many of its advantages would be readily understood and appreciated.

FIG. 1 illustrates a flowchart for session transfer mechanism between devices.

FIG. 2 illustrates session transfer of an active session from a mobile device to a desktop device.

FIG. 3 illustrates session reclaiming of an active session from a desktop device to a mobile device.

FIG. 4 illustrates session transfer of an active session from a mobile device to a desktop device using an SIP server.

### DETAILED DESCRIPTION OF THE PREFERRED EMBODIMENTS

The present invention relates to a method for session transfer mechanism between communication devices. Hereinafter, this specification will describe the present invention according to the preferred embodiments of the present invention. However, it is to be understood that limiting the description to the preferred embodiments of the invention is merely to facilitate discussion of the present invention and it is envisioned that those skilled in the art may devise various modifications and equivalents without departing from the scope of the appended claims.

The present invention relates to a method for session transfer mechanism between communication devices. The session transfer mechanism includes session transfer and session reclaiming between devices. The present invention provides a mechanism that is capable of transferring and automatically reclaiming an active session from one device to another without a user having to be aware of addressing information of the related devices.

The present invention describes a simple and automated method of session transfer and session reclaiming across devices by addressing several limitations of the conventional session transfer mechanism. The first is, the present invention incorporates location information of the related devices as to enable seamless session transfer without user intervention and the second is leveraging on the location information so as to allow an authenticated device to reclaim an ongoing active session from another device.

The method of the present invention tracks the location of active devices, devices having active sessions and measures its distance from surrounding devices, that are passive devices or target devices, to allow a single-button press on any given active device for transferring an active session to the closest passive device in the vicinity. The passive device where the active session has been successfully transferred is now referred to as the present active device and is in control of the active session. The previously active device is capable of reclaiming the session back onto to itself from the present active device by a single-button press.

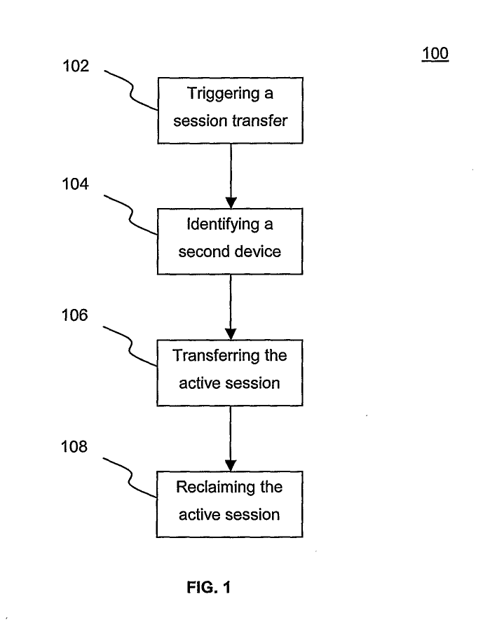

Reference is first being made to FIG. 1. FIG. 1 illustrates a flowchart for session transfer mechanism between devices. The method (100) for session transfer mechanism begins with triggering a session transfer (102) on a first device having an active session with a corresponding device. The first device and the corresponding device may be a mobile device or an immobile device. In some instances, the first device may be referred to as the active device or the originator device.

Upon triggering a session transfer (102), a second device is identified (104) from a plurality of devices for the session transfer. The second device may be a mobile device or an immobile device. In some instances, the second device may be referred to as the passive device or the target device. Once the second device has been identified, transferring the active session (106) transpiring between the first device and the corresponding device to between the second device and the corresponding device is initiated.

The description and drawings herein refer to the first device as a mobile device, the second device as a desktop device and the corresponding device as the corresponding node (CN) for convenience of explanation and illustration.

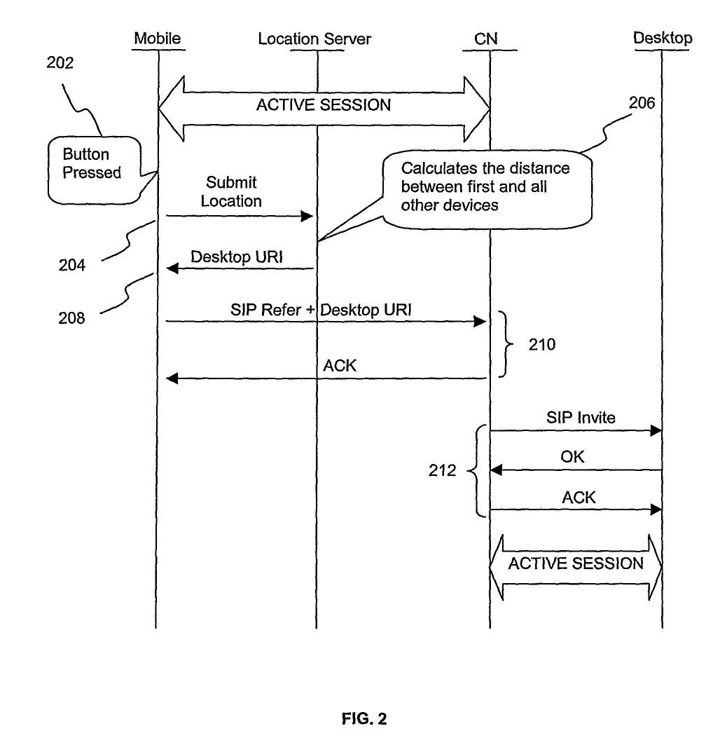

Reference is now being made to FIG. 2. FIG. 2 illustrates session transfer of an active session from a mobile device to a desktop device. The session transfer is implemented for an active session transpiring between the mobile device and a corresponding node. The session transfer begins with triggering the session transfer (102) by depressing a transfer button (202) on the first device, in this case the mobile device. This consequently causes the mobile device to send its location information (204) to a location server.

In another embodiment of the present invention, the triggering of the session transfer (102) may comprise multiple buttons depressing as opposed to a single button press, wherein the former provides flexibility in identifying the second device (104) based on information not limited to only location. Other possible information may include user-defined groups or specifically designated devices.

Once the session transfer has been triggered, a second device from a plurality of devices is identified based on the distance of the same from the mobile device that is calculated in the location server.

Identifying the second device (104) begins with storing a location information of each device of the plurality of devices in the location server. In the case of mobile devices, the location of the mobile devices are dynamically tracked and stored by the location server.

In the case of immobile devices, the location of the immobile devices are configured and stored by the location server.

Identifying the second device (104) continues with the location server calculating (206) distance information between the mobile device and each device of the plurality of devices. The location server then identifies the second device from the plurality of devices having a closest distance to the mobile device, in this case the desktop device. To initiate transferring of the session, the location server sends a Uniform Resource Identifier (URI) of the desktop device (208) to the mobile device.

Transferring of the active session (106) transpiring between the mobile device and the corresponding node to between the desktop device and the corresponding node includes two handshaking occurrences. For this purpose, the location server implements a Session Initiation Protocol (SIP) that initiates a SIP REFER handshaking (210) and a SIP INVITE handshaking (212).

The SIP REFER handshaking (210) occurs between the mobile device and the corresponding node, wherein the SIP REFER handshaking comprises sending the Uniform Resource Identifier of the desktop device from the mobile device to the corresponding node. The SIP INVITE handshaking (212) occurs between the corresponding node and the desktop device. Upon successfully executing the two handshaking, the active session is transferred from between the mobile device and the corresponding node to between the desktop device and the corresponding node. The point of control lies in the desktop device. However, the mobile device has the capability of reclaiming the transferred active session.

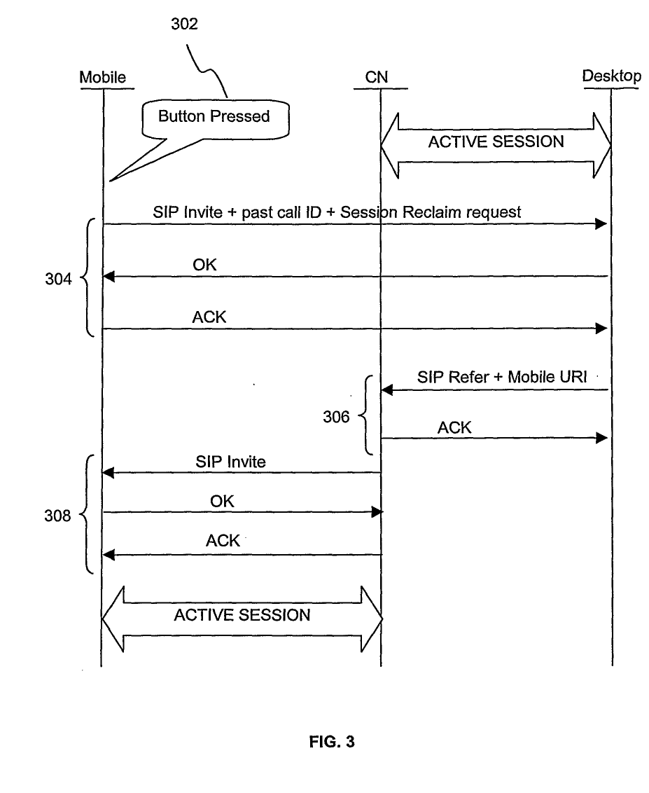

Reference is now being made to FIG. 3. FIG. 3 illustrates session reclaiming of an active session from a desktop device to a mobile device. If a session reclaiming is triggered on the first device, reclaiming the active session (108) transpiring between the second device and the corresponding device is initiated. Reclaiming the active session (108) includes triggering a session reclaim on the first device, in this case the mobile device and reclaiming the active session transpiring between the second device, in this case the desktop device and the corresponding device to between the mobile device and the corresponding device.

The session reclaim begins with triggering the session reclaim by depressing a reclaim button (302) on the mobile device. This consequently invokes a SIP INVITE handshaking (304) between the mobile device and the desktop device, wherein the SIP INVITE comprises sending a session identification and a session reclaim message from the mobile device to the desktop device. The session identification is often referred to as a call ID and the session reclaim message is an extra tag denoting that this SIP INVITE handshaking is for the purpose of triggering a session reclaiming as opposed to the SIP INVITE handshaking during transferring or reclaiming of an active session.

Reclaiming the active session transpiring between the desktop device and the corresponding node to between the mobile device and the corresponding node includes two handshaking occurrences, a SIP REFER handshaking (306) and a SIP INVITE handshaking (308). The SIP REFER handshaking (306) occurs between the desktop device and the corresponding node, wherein the SIP REFER handshaking comprises sending the Uniform Resource Identifier of the mobile device from the desktop device to the corresponding node. The SIP INVITE handshaking (308) occurs between the corresponding node and the mobile device. Upon successfully executing the two handshaking, the active session is reclaimed from between the desktop device and the corresponding node to between the mobile device and the corresponding node.

The session transfer is not limited to a single tier transfer that comprises transferring of the active session (106) transpiring between the mobile device and the corresponding device to between the desktop device and the corresponding device. In another embodiment of the present invention, transferring of the active session (106) may occur more than once. For instance, a dual tier transfer comprises firstly transferring the active session transpiring between a mobile device and a corresponding node to between a first desktop device and the corresponding node, and secondly, transferring the active session transpiring between the first desktop device and the corresponding node to between a second desktop device and the corresponding node. In this case, the session reclaiming may be triggered by any one of the devices that the active session was transferred from, which is either the mobile device or the first desktop device.

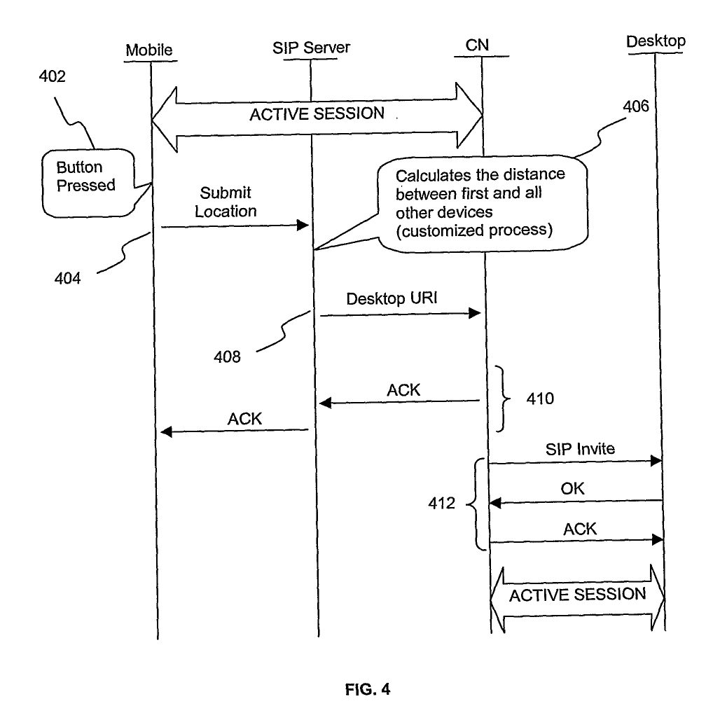

In another embodiment of the present invention, the location server may be substituted by an SIP server. Reference is now being made to FIG. 4. FIG. 4 illustrates session transfer of an active session from a mobile device to a desktop device using an SIP server.

The session transfer begins with triggering the session transfer (102) by depressing a transfer button (402) on the first device, in this case the mobile device. This consequently causes the mobile device to send its location information (404) to the SIP server. Once the session transfer has been triggered, a second device from a plurality of devices is identified based on the distance of the same from the mobile device calculated in the SIP server using a customized process (406).

Upon identifying the second device, in this case the desktop device, the SIP servers sends a Uniform Resource Identifier of the desktop device (408) to the corresponding device, in this case the corresponding node. A cascaded acknowledgement (410) takes place prior to transferring of the active session. The cascaded acknowledgement (410) comprises the corresponding node sending an acknowledgment message to the SIP sever and the SIP server consequently sending an acknowledgment message to the mobile device to indicate that the session transfer may be executed.

Thereafter an SIP INVITE handshaking (412) occurs between the corresponding node and the desktop device. Upon successfully executing the handshaking, the active session is transferred from between the mobile device and the corresponding node to between the desktop device and the corresponding node. The point of control lies in the desktop device. However, the mobile device has the capability of reclaiming the transferred active session.

1. A method (100) for session transfer mechanism, the method comprising steps of:
triggering a session transfer (102) on a first device having an active session with a corresponding device;
identifying a second device (104) from a plurality of devices for the session transfer;
transferring the active session (106) transpiring between the first device and the corresponding device to between the second device and the corresponding device; and
reclaiming the active session (108) transpiring between the second device and the corresponding device if a session reclaiming is triggered on the first device.

2. The method according the claim 1, wherein the first device, the corresponding device and the second device comprises a mobile device or an immobile device.

3. The method according the claim 1, wherein triggering the session transfer (102) comprises the steps of:
depressing a transfer button (202) on the first device; and
sending a location information (204) of the first device to a location server.

4. The method according the claims 1 and 3, wherein identifying the second device (104) comprises the steps of:
storing in the location server, a location information of each device of the plurality of devices;
calculating in the location server (206), a distance information between the first device and each device of the plurality of devices;
identifying in the location server, the second device from the plurality of devices having a closest distance to the first device; and
sending an Uniform Resource Identifier of the second device (208) from the location server to the first device.

5. The method according the claims 1 and 4, wherein transferring the active session (106) comprises the steps of:
SIP REFER handshaking (210) between the first device and the corresponding device, wherein the SIP REFER handshaking comprises sending the Uniform Resource Identifier of the second device from the first device to the corresponding device; and
SIP INVITE handshaking (212) between the corresponding device and the second device.

6. The method according the claim 1, wherein reclaiming the active session (108) comprises the steps of:
triggering a session reclaim on the first device; and
reclaiming the active session transpiring between the second device and the corresponding device to between the first device and the corresponding device.

7. The method according the claim 6, wherein triggering a session reclaim comprises the steps of:
depressing a reclaim button (302) on the first device; and
SIP INVITE handshaking (304) between the first device and the second device, wherein the SIP INVITE comprises sending a session identification and a session reclaim message from the first device to the second device.

8. The method according the claims 4 and 6, wherein reclaiming the active session (108) comprises the steps of:
SIP REFER handshaking (306) between the first device and the corresponding device, wherein the SIP REFER handshaking comprises sending the Uniform Resource Identifier of the first device from the second device to the corresponding device; and
SIP INVITE handshaking (308) between the corresponding device and the first device.

9. The method according the claim 3, wherein the location server comprises a SIP server.

10. The method according the claims 1 and 9, wherein identifying the second device (104) comprises the steps of:
storing in the SIP server, a location information of each device of the plurality of devices;
calculating in the SIP server (406) using a customized process, a distance information between the first device and each device of the plurality of devices;
identifying in the SIP server, the second device from the plurality of devices having a closest distance to the first device,
sending an Uniform Resource Identifier of the second device (408) from the SIP server to the corresponding device; and
receiving a cascaded acknowledgement (410) from the corresponding node to the SIP server to the first device.

11. The method according the claims 1 and 9, wherein transferring the active session (106) comprises SIP INVITE handshaking (412) between the corresponding device and the second device.
